(19) United States
(12) Patent Application Publication
(10) Pub. No.: US 2016/0291741 A1
(43) Pub. Date: Oct. 6, 2016

(54) ARRAY SUBSTRATE, TOUCH DISPLAY PANEL AND TOUCH DISPLAY DEVICE

(71) Applicants: Shanghai Tianma Micro-Electronics Co., Ltd., Shanghai (CN); Tianma Micro-Electronics Co., Ltd., Shenzhen (CN)

(72) Inventors: Xingyao Zhou, Shanghai (CN); Lingxiao Du, Shanghai (CN); Qijun Yao, Shanghai (CN)

(21) Appl. No.: 14/821,674

(22) Filed: Aug. 7, 2015

(30) Foreign Application Priority Data
Apr. 1, 2015 (CN) 201510153206.2

(51) Int. Cl. G06F 3/047; G09G 5/00; G06F 3/044

(52) U.S. Cl. CPC G06F 3/047; G06F 3/044; G09G 5/003; G09G 2300/0426

(57) ABSTRACT

There are provided an array substrate, a touch display panel and a touch display device. The array substrate includes a common electrode layer and a driver circuit. The common electrode layer is divided into multiple self-capacitive electrodes that are connected to the driver circuit through multiple touch leads. Each touch lead is electrically connected to one of the self-capacitive electrodes via a via hole. The array substrate also includes a first groove or gap formed in the self-capacitive electrode in a region where a self-capacitive electrode overlaps a touch lead, and at least one of the self-capacitive electrodes corresponding to the via hole has at least a predetermined thickness.

### CROSS-REFERENCES TO RELATED APPLICATIONS

The present application claims the priority to Chinese Patent Application No. 201510153206.2, entitled “ARRAY SUBSTRATE, TOUCH DISPLAY PANEL AND TOUCH DISPLAY DEVICE”, filed on Apr. 1, 2015 with the State Intellectual Property Office of the PRC, the content of which is incorporated herein by reference in its entirety.

### BACKGROUND OF THE INVENTION

1. Field

The disclosure relates to the field of touch screen technology, and in particular, to an array substrate, a touch display panel, and a touch display device.

2. Background

Capacitive touch screens can be classified into two kinds based on the detection method for detecting capacitance changes: self-capacitive touch screens and mutual capacitive touch screens. Touch display devices can be classified into three kinds based on the relative position of a glass panel, a touch panel and a display panel: in-cell touch display devices, on-cell touch display devices and out-cell touch display devices. The in-cell touch screen becomes a mainstream of the development trend in touch technology due to its advantages of high integration, thin profile and superior performance.

Currently, existing touch display devices mainly employ in-cell mutual capacitive touch technology. Two separate driver circuits operate together for the electrode of the display panel and the touch electrode of the touch panel in the touch display device, which results in a high cost of the touch display device.

### BRIEF SUMMARY OF THE INVENTION

In view of the above, embodiments of the disclosure provide an array substrate, a touch display panel, and a touch display device to solve the high-cost problem of the touch display devices employing the in-cell mutual capacitive touch technology.

To achieve the above object, embodiments of the disclosure provide the following technical solutions.

An array substrate includes a common electrode layer and a driver circuit. The common electrode layer is divided into multiple self-capacitive electrodes. The self-capacitive electrodes are electrically connected to the driver circuit through touch leads; and

each touch lead is electrically connected to a self-capacitive electrode via a via hole, a first groove or gap is formed in the self-capacitive electrode in a region where a self-capacitive electrode overlaps a touch lead, and at least one of the self-capacitive electrodes corresponding to the via hole has at least a predetermined thickness.

A touch display panel includes the above array substrate.

A touch display device includes the above touch display panel.

Compared with the conventional technology, the technical solutions according to the disclosure have a number of advantages as follows.

For the array substrate, the touch display panel and the touch display device according to the disclosure, the common electrode layer on the array substrate is divided into multiple self-capacitive electrodes which can serve as common electrodes and touch electrodes, the self-capacitive electrodes are electrically connected to the driver circuit of the array substrate through touch leads. Thus, a touch driver circuit and a display circuit are integrated together, thereby reducing the costs of the touch display panel and the touch display device. Since the first groove or gap is formed in the self-capacitive electrode in a region where the self-capacitive electrode overlaps the touch lead, the parasitic capacitance between the self-capacitive electrode and the touch lead is reduced.

### BRIEF DESCRIPTION OF THE DRAWINGS

The drawings to be used in the description of embodiments or the conventional technology are described briefly as follows, so that technical solutions according to the embodiments of the present disclosure or according to the conventional technology may become clearer. Apparently, the drawings referred in the following description only illustrate some embodiments of the disclosure and should not be taken to limit the invention. Those skilled in the art would recognize other variations, modifications, and alternatives after reading this disclosure.

FIG. 1 is a schematic section view of a structure of an array substrate according to the disclosure;

FIG. 2 is a schematic section view of a structure of another array substrate according to the disclosure;

FIG. 3 is a top view of an array substrate according to the disclosure;

FIG. 4a is a top view of a structure of an array substrate according to the disclosure in which the touch leads has a via hole region; and

FIG. 4b is a top view of a structure of an array substrate according to the disclosure in which the touch leads has no via hole region.

### DETAILED DESCRIPTION OF THE INVENTION

Technical solutions according to embodiments of the disclosure are described clearly and completely in conjunction with the accompanying drawings hereinafter. It is obvious that the described embodiments are only a part rather than all of the embodiments according to the disclosure. Any other embodiments obtained by those skilled in the art based on the embodiments in the disclosure without any creative work fall in the scope of protection of the disclosure.

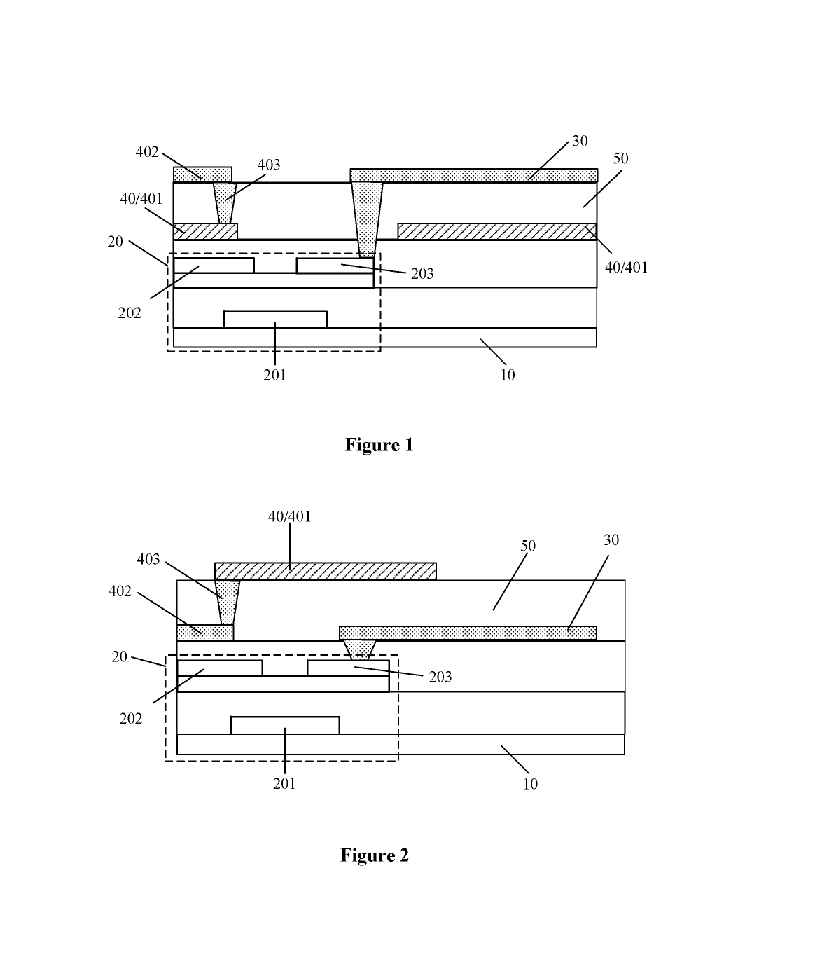

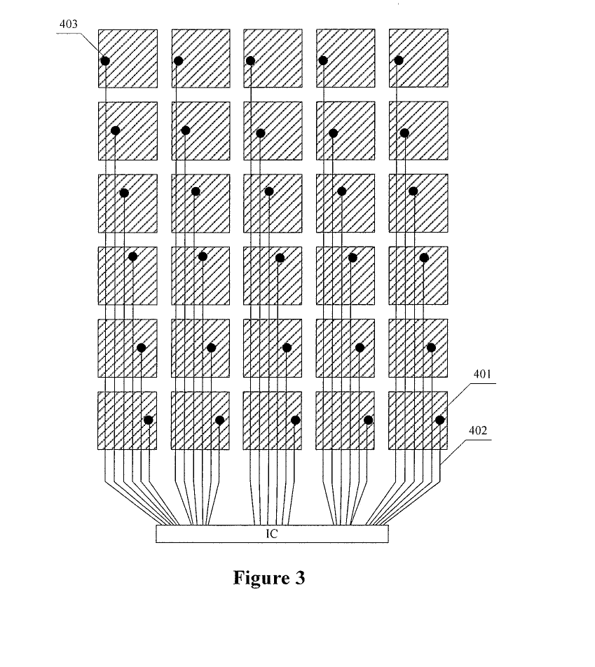

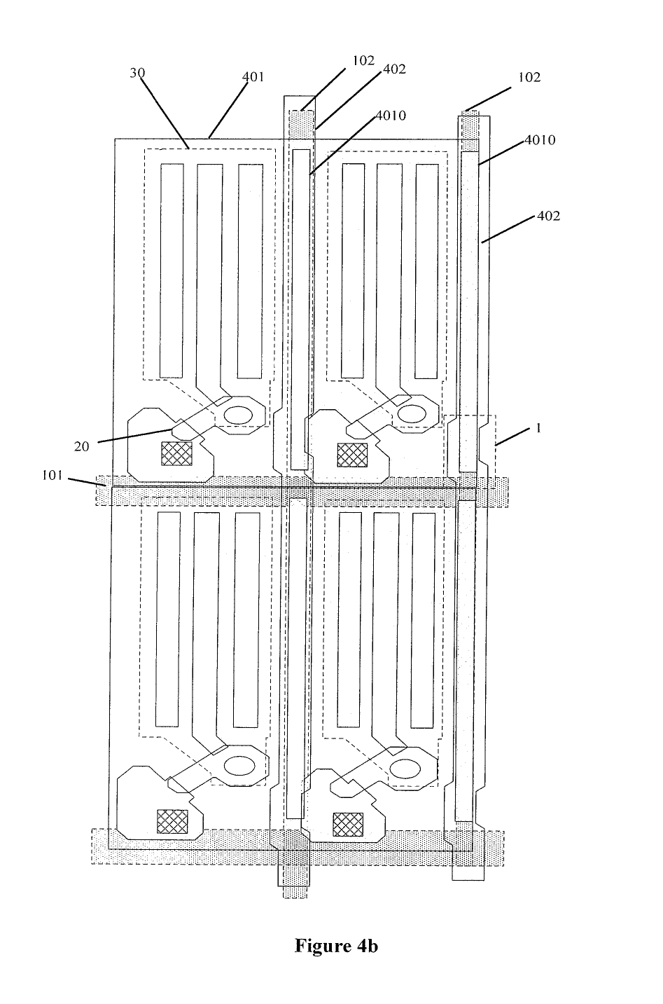

An array substrate is provided according to an embodiment of the disclosure. As shown in FIG. 1, FIG. 4a and FIG. 4b, the array substrate includes: a substrate 10, multiple gate lines 101 and multiple data lines 102 arranged on the substrate 10, and multiple pixel units surrounded by the gate lines 101 and the data lines 102. The pixel units each include a thin film transistor 20 and a pixel electrode 30. A gate 201 of the thin film transistor 20 is electrically connected to the gate line 101, a source 202 of the thin film transistor 20 is electrically connected to the data line 102, and a drain 203 of the thin film transistor 20 is electrically connected to the pixel electrode 30. The array substrate further includes a common electrode layer 40 arranged between the thin film transistor 20 and the pixel electrode 30, and an insulation layer 50 is arranged between the common electrode layer 40 and the pixel electrode 30. Optionally, as shown in FIG. 2, the pixel electrode 30 is arranged between the thin film transistor 20 and the common electrode layer 40, and the insulation layer 50 is arranged between the pixel electrode 30 and the common electrode layer 40 in other embodiments of the disclosure.

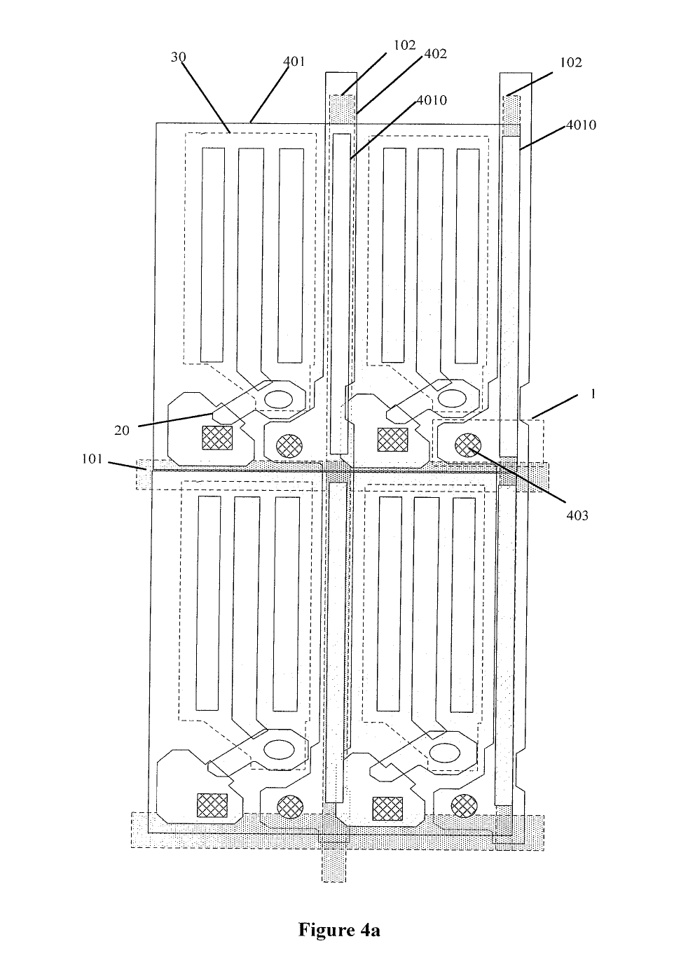

In the embodiment, as shown in FIG. 3, as can be seen from the top view of the array substrate, the common electrode layer 40 is divided into multiple block-shaped self-capacitive electrodes 401 insulated from each other, and the self-capacitive electrodes 401 are electrically connected to a driver circuit IC of the array substrate through touch leads 402. The driver circuit IC is configured to provide a touch signal for the self-capacitive electrode 401 so that the self-capacitive electrode 401 serves as a touch electrode. And the driver circuit IC is also configured to provide a common voltage for the self-capacitive electrode 401 so that the self-capacitive electrode 401 serves as a common electrode. Furthermore, the driver circuit IC is electrically connected to the data line 102 and the gate line 101 to provide a scan signal for the gate line 101 and provide a data signal for the data line 102.

Based on this, the self-capacitive technology is used in the array substrate according to the embodiment, and the common electrode layer 40 is divided into multiple block-shaped self-capacitive electrodes 401. A projection of the self-capacitive electrode 401 covers the projections of multiple pixel units in a direction perpendicular to the array substrate. The self-capacitive electrode 401 may serve as the common electrode and may also serve as the touch electrode. Optionally, a touch driver circuit and a touch display circuit are integrated into one driver circuit

IC in one embodiment, and it is not necessary to drive the touch driver circuit and the touch display circuit by using two driver circuits respectively, thereby reducing the cost of the array substrate.

In the embodiment, as shown in FIG. 1 and FIG. 2, the touch lead 402 is electrically connected to the self-capacitive electrode 401 via a via hole 403. Optionally, the touch lead 402 is arranged in the same layer with the pixel electrode 30. Optionally, the touch lead 402 and the pixel electrode 30 are formed in one fabrication process, but the disclosure is not limited thereto. Further, the touch lead 402 in the embodiment is made of molybdenum, aluminum or copper, but the disclosure is not limited thereto.

As shown in FIG. 4a, a first groove or gap 4010 is formed in the self-capacitive electrode 401, the first groove or gap 4010 is formed in a region where the self-capacitive electrode 401 is overlapped with the touch lead 402, and the self-capacitive electrode 401 corresponding to the via hole 403 has at least a predetermined thickness. Optionally, the projection of the self-capacitive electrode 401 completely covers the projection of the via hole 403 in a direction perpendicular to the array substrate. Optionally, no groove or gap is formed in the self-capacitive electrode 401 corresponding to the via hole 403. Optionally, a second groove (not shown in FIG. 4a) is formed in the self-capacitive electrode 401 corresponding to the via hole 403, and the depth of the second groove is less than the depth of the first groove or gap 4010.

As shown in FIG. 1, in the case that the common electrode layer 40 is arranged below the pixel electrode 30, it is ensured that the self-capacitive electrode 401 of a predetermined thickness is arranged below the via hole 403, to avoid affecting the layer below the via hole when the via hole is etched. Optionally, as shown in FIG. 2, in the case that the common electrode layer 40 is arranged above the pixel electrode 30, it is ensured that the self-capacitive electrode 401 can completely covers the via hole 403, to prevent the via hole 403 from being etched.

Furthermore, the first groove or gap 4010 is formed in the self-capacitive electrode 401 in a region where the self-capacitive electrode 401 overlaps the touch lead 402, as shown in FIG. 4a and FIG. 4b. According to the disclosure, the overlap between the touch lead 402 and the self-capacitive electrode 401 is reduced by etching the self-capacitive electrode 401 to form the first groove or gap 4010, therefore, the parasitic capacitance between the touch lead 402 and the self-capacitive electrode 401 is reduced, and the effect caused by the parasitic capacitance on the performance of the array substrate, a touch display panel and a touch display device is reduced.

As shown in FIG. 4a and FIG. 4b, the first groove or gap 4010 on the self-capacitive electrode 401 has a stripe-shaped structure. The projection of the first groove or gap 4010 is arranged between the pixel units in the direction perpendicular to the array substrate. An extending direction of the first groove or gap 4010 is the same as an extending direction of the data line 102. The first groove or gap 4010 has a width in a range between 0.1 μm and 10 μm. In the embodiment, the difference between a groove and a gap lies in that the groove means that the self-capacitive electrode in a specific region is etched partly and is not etched through, and the gap means that the self-capacitive electrode in a specific region is etched fully. Optionally, the gap is arranged on the self-capacitive electrode 401, the manufacture process of the gap is simple, and the parasitic capacitance is reduced greatly due to the gap.

It should be noted that, in a region surrounded by a broken line block 1 as shown in FIG. 4a and FIG. 4b, the shape of the self-capacitive electrode 401 corresponding to the via hole 403 is different from the shape of the self-capacitive electrode 401 corresponding to the touch lead 402 without the via hole 403. Optionally, the shape of the self-capacitive electrode 401 below the via hole 403 may be round or square, which is not limited herein, as long as the self-capacitive electrode 401 corresponding to the via hole 403 can completely covers the via hole 403.

In the array substrate according to the disclosure, the common electrode layer is divided into multiple self-capacitive electrodes which can serve as the common electrode and the touch electrode, the self-capacitive electrodes are electrically connected to the driver circuit of the array substrate through touch leads, and thus a touch driver circuit and a display circuit are integrated together, thereby reducing the costs of the touch display panel and the touch display device. The touch display device employing the in-cell self-capacitive touch technology has a better performance in a waterproof property, a report rate, and a suspension property. Furthermore, since the first groove or gap is formed in the self-capacitive electrode in a region where the self-capacitive electrode is overlapped with the touch lead, the parasitic capacitance between the self-capacitive electrode and the touch lead is reduced.

A touch display panel is provided according to an embodiment of the disclosure. The touch display panel includes the array substrate according to any one of the above embodiments, a color filter substrate arranged opposite to the array substrate, and a liquid crystal layer arranged between the array substrate and the color filter substrate.

A touch display device is provided according to an embodiment of the disclosure. The touch display device includes the above touch display panel.

For the touch display panel and the touch display device according to the disclosure, the common electrode layer is divided into multiple self-capacitive electrodes which can serve as the common electrode and the touch electrode, the self-capacitive electrodes are electrically connected to the driver circuit of the array substrate through touch leads, and thus a touch driver circuit and a display circuit are integrated together, thereby reducing the costs of the touch display panel and the touch display device. The touch display device employing the in-cell self-capacitive touch technology has a better performance in a waterproof property, a report rate, and a suspension property. Furthermore, since the first groove or gap is formed in the self-capacitive electrode in a region where the self-capacitive electrode overlaps the touch lead, the parasitic capacitance between the self-capacitive electrode and the touch lead is reduced.

The embodiments of the disclosure are described herein in a progressive manner, with an emphasis placed on the difference between one embodiment and the other embodiments; hence, for the same or similar parts among the embodiments, one can refer to the other embodiments. For the device disclosed in the embodiments, the corresponding descriptions are relatively simple because the device corresponds to the method disclosed in the embodiments. The relevant parts may refer to the description of the method parts.

The above description of the embodiments disclosed herein enables those skilled in the art to implement or use the disclosure. Numerous modifications to the embodiments are apparent for those skilled in the art, and the general principle herein can be implemented with other embodiments without deviation from the spirit or scope of the disclosure. Therefore, the disclosure should not be limited to the embodiments described herein, but has the widest scope consistent with the principle and novel features disclosed herein.

What is claimed is:

1. An array substrate, comprising a common electrode layer and a driver circuit,
wherein the common electrode layer is divided into a plurality of self-capacitive electrodes, and the self-capacitive electrodes are electrically connected to the driver circuit through a plurality of touch leads; and
each touch lead is electrically connected to one of the self-capacitive electrodes via a via hole, a first groove or gap is formed in the self-capacitive electrode in a region where a self-capacitive electrode overlaps a touch lead, and at least one of the self-capacitive electrodes corresponding to the via hole has at least a predetermined thickness.

2. The array substrate according to claim 1, further comprising a second groove formed in a self-capacitive electrode corresponding to the via hole, the second groove having a depth less than a depth of the first groove or gap; or no groove or gap is formed in the self-capacitive electrode corresponding to the via hole.

3. The array substrate according to claim 2, wherein a self-capacitive electrode corresponding to a via hole completely covers the via hole, and a shape of the self-capacitive electrode corresponding to the via hole is different from a shape of the self-capacitive electrode in other regions.

4. The array substrate according to claim 3, further comprising:
a plurality of gate lines and a plurality of data lines; and
a plurality of pixel units surrounded by the gate lines and the data lines, each of the pixel units comprising a thin film transistor and a pixel electrode, the thin film transistor having a gate electrically connected to the gate line, a source electrically connected to the data line, and a drain electrically connected to the pixel electrode, and
wherein a projection of the first groove or gap is arranged between pixel units in a direction perpendicular to the array substrate.

5. The array substrate according to claim 4, wherein the common electrode layer is arranged between the thin film transistors and the pixel electrodes, and an insulation layer is arranged between the common electrode layer and the pixel electrodes.

6. The array substrate according to claim 4, wherein the pixel electrodes are arranged between the thin film transistors and the common electrode layer, and an insulation layer is arranged between the pixel electrodes and the common electrode layer.

7. The array substrate according to claim 5, wherein the touch leads are arranged in a same layer with the pixel electrodes.

8. The array substrate according to claim 7, wherein the first groove or gap has a stripe-shaped structure.

9. The array substrate according to claim 8, wherein an extending direction of the first groove or gap is the same as an extending direction of the data line.

10. The array substrate according to claim 9, wherein the first groove or gap has a width in a range between 0.1 μm and 10 μm.

11. The array substrate according to claim 10, wherein the self-capacitive electrodes are block-shaped electrodes, and a projection of the self-capacitive electrodes covers a projection of the pixel units in the direction perpendicular to the array substrate.

12. The array substrate according to claim 11, wherein the touch leads are made of molybdenum, aluminum, or copper.

13. A touch display panel comprising an array substrate, the array substrate comprising a common electrode layer and a driver circuit,
wherein the common electrode layer is divided into a plurality of self-capacitive electrodes, and the self-capacitive electrodes are electrically connected to the driver circuit through a plurality of touch leads; and
each touch lead is electrically connected to one of the self-capacitive electrodes via a via hole, a first groove or gap is formed in the self-capacitive electrode in a region where a self-capacitive electrode overlaps a touch lead, and at least one of the self-capacitive electrodes corresponding to a via hole has at least a predetermined thickness.

14. The touch display panel according to claim 13, wherein the array substrate further comprises a second groove formed in the self-capacitive electrode corresponding to the via hole, the depth of the second groove is less than the depth of the first groove or gap or no groove or gap is formed in the self-capacitive electrode corresponding to the via hole.

15. The touch display panel according to claim 14, wherein a self-capacitive electrode corresponding to a via hole completely covers the via hole, and a shape of the self-capacitive electrode corresponding to the via hole is different from a shape of the self-capacitive electrode in other regions.

16. The touch display panel according to claim 15, wherein the array substrate further comprises:
a plurality of gate lines and a plurality of data lines; and
a plurality of pixel units surrounded by the gate lines and the data lines, each of the pixel units comprising a thin film transistor and a pixel electrode, the thin film transistor having a gate electrically connected to the gate line, a source electrically connected to the data line, and a drain electrically connected to the pixel electrode, and
wherein a projection of the first groove or gap is arranged between pixel units in a direction perpendicular to the array substrate.

17. The touch display panel according to claim 16, wherein the common electrode layer is arranged between the thin film transistors and the pixel electrodes, and an insulation layer is arranged between the common electrode layer and the pixel electrodes.

18. The touch display panel according to claim 16, wherein the pixel electrodes are arranged between the thin film transistors and the common electrode layer, and an insulation layer is arranged between the pixel electrodes and the common electrode layer.

19. A touch display device comprising a touch display panel, the touch display panel comprising an array substrate comprising a common electrode layer and a driver circuit,
wherein the common electrode layer is divided into a plurality of self-capacitive electrodes electrically connected to the driver circuit through a plurality of touch leads; and
each touch lead is electrically connected to one of the self-capacitive electrodes via a via hole, a first groove or gap is formed in a self-capacitive electrode, wherein the first groove or gap is formed in a region where a self-capacitive electrode overlaps a touch lead, and at least one of the self-capacitive electrodes corresponding to a via hole has at least a predetermined thickness.
